(19) United States
(12) Patent Application Publication
(10) Pub. No.: US 2017/0285902 A1
(43) Pub. Date: Oct. 5, 2017

(54) Modifying Settings of an Electronic Test or Measurement Instrument

(71) Applicant: Teledyne LeCroy, Inc., Thousand Oaks, CA (US)

(72) Inventors: Hitesh Patel, Pompton Lakes, NJ (US); Jonathan C. Libby, Gray, ME (US); Roger Delbue, Monroe, NY (US); Robert Mart, Pearl River, NY (US); Christopher Busso, Westwood, NJ (US)

(73) Assignee: Teledyne LeCroy, Inc.

(21) Appl. No.: 15/386,064

(22) Filed: Dec. 21, 2016

Related U.S. Application Data
(60) Provisional application No. 62/318,170, filed on Apr. 4, 2016.

(51) Int. Cl. G06F 3/0486; G06F 3/0488; G06F 3/0482

(52) U.S. Cl. CPC G06F 3/0486; G06F 3/0482; G06F 3/0488

(57) ABSTRACT

In general, the subject matter described in this disclosure can be embodied in methods, systems, and program products that include presenting, by electronic device, a user interface on a display of the electronic device. The user interface includes a trace of a first waveform, an element that presents multiple properties of the first waveform or a channel on which the first waveform was acquired, a trace of a second waveform, and a second user interface element that presents multiple properties of the second waveform or a channel on which the second waveform was acquired. The electronic device can receive user input that selects the first user interface element and then selects the second user interface element. The electronic device can apply one or more settings of the trace of the first waveform to the trace of the second waveform.

### TECHNICAL FIELD

This document generally relates to modifying settings of an electronic test or measurement instrument.

### BACKGROUND

Electronic test or measurement instruments are able to capture an electrical signal (e.g., a waveform) and present a trace of the captured signal on a display. In addition to displaying the trace of the electrical signal, the electronic test or measurement instrument may be able to apply a mathematical process to the captured waveform. This processing can transform the captured signal and present a transformed version of the captured signal as a separate trace, or extract parameters from the captured waveform.

### SUMMARY

This document describes techniques, methods, systems, and other mechanisms for modifying settings of an electronic test or measurement instrument.

Particular implementations can, in certain instances, realize one or more of the following advantages. A user may change a source of a trace quickly and with a single user input action. A user may be able to configure traces and other parameters of a test or measurement instrument with fewer user input actions, greater accuracy, and fewer errors.

The details of one or more implementations are set forth in the accompanying drawings and the description below. Other features, objects, and advantages will be apparent from the description and drawings, and from the claims.

### DESCRIPTION OF DRAWINGS

FIG. 1 shows a user interface of an oscilloscope.

FIG. 2 shows a user input action for copying a configuration of one trace to another.

FIG. 3 shows a user input action for changing a source of a trace.

FIG. 4 shows a user input action for adding a trace.

FIG. 5 shows a user input action for changing a source for the trigger.

FIG. 6 shows a user input action for removing a trace.

FIG. 7 shows a user input action for changing a cursor setting.

FIG. 8 shows a user interface that displays delta labels for a trace.

FIG. 9 shows a user input action for pinch zooming.

FIG. 10 shows a decision scheme for a user input action.

FIG. 11 shows a user input action for zooming.

FIG. 12 shows a flowchart of a process for modifying settings of an electronic test or measurement instrument.

FIG. 13 is a block diagram of computing devices that may be used to implement the systems and methods described in this document.

Like reference symbols in the various drawings indicate like elements.

### DETAILED DESCRIPTION

This document generally describes modifying settings of an electronic test or measurement instrument.

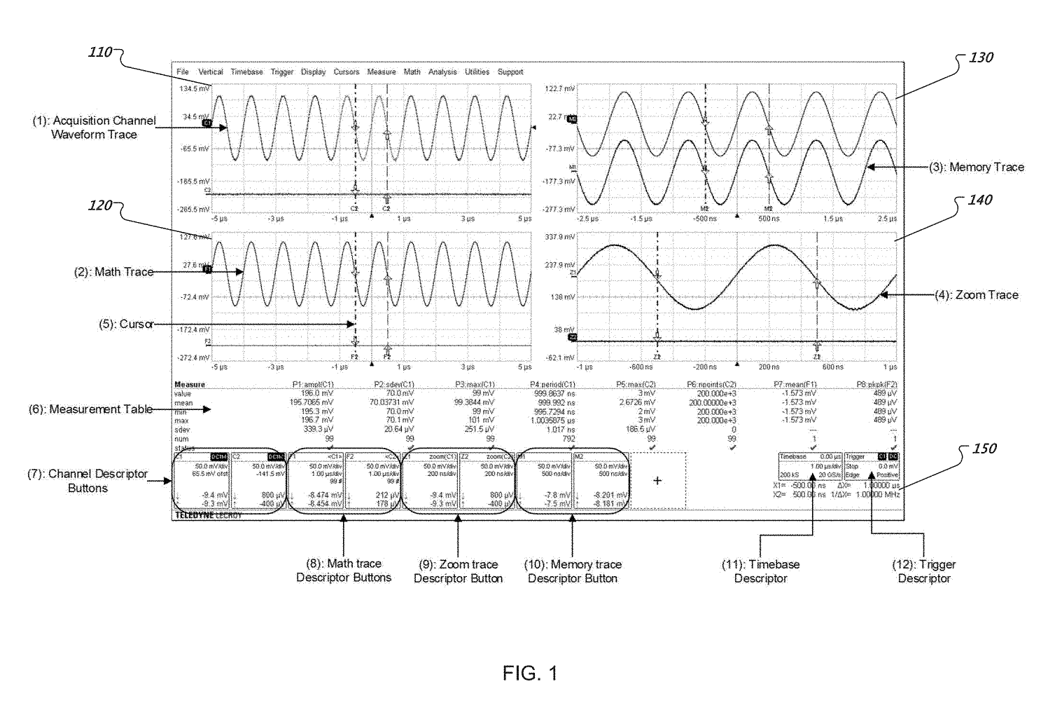

FIG. 1 shows a user interface of an oscilloscope. Some traditional oscilloscopes plot a trace of a single acquired signal on a grid of time versus amplitude (e.g., voltage). FIG. 1 shows a user interface that includes multiple display grids, and some of the display grids show traces that are not simply signals that are being acquired in real time. The top left grid 110 presents an acquisition channel trace (1), the bottom left grid 120 presents a math trace (2), the top right grid 130 presents a memory trace (3), and the bottom right grid 140 presents a zoom trace (4).

Each display grid may be a portion of the user interface that can display one or more traces. The traces may illustrate a series of data values that are charted in the grid by time domain (on the x-axis) and amplitude (on the y-axis). The scale and distribution of values represented on each axis may vary from grid to grid. The charted data values do not necessarily have to be acquired and displayed in real time (e.g., within 0.001, 0.01, or 0.1 seconds of being received at a probe). Rather, the trace of data values that are presented in any particular grid can be a representation of a stored trace, a mathematical modification of another trace (whether that other trace be one that is presently being acquired or a trace that is stored), or a zoomed version of another trace (whether that other trace is one that is presently being acquired, that is stored, or that is a mathematical transformation of another trace).

In greater detail, the top-left grid 110 presents two acquisition channel traces. In other words, this grid may display those one or more waveforms that are currently being acquired by the hardware on input channels of the hardware, for example, through the use of oscilloscope probes. In this example, the grid shows two traces, C1 and C2, that represent signals acquired from two respective oscilloscope channels, channels 1 and 2. Trace C1 shows a sinusoidal waveform, and trace C2 shows a flat line (e.g., because the corresponding probe may not be connected to a signal generating source).

The oscilloscope display presents a cursor (5) (sometimes referred to as a “marker” over the display grid 110). A cursor is a measurement user interface element that identifies the values at a particular part of a trace at which the trace and the cursor intersect. In this example, the cursor is a vertical line, and the electronic display can present the voltage value at a location at which the vertical line intersects the trace, and can display the time value at which the vertical line is located (and thus also at the location/voltage which the intersection with the trace occurs). Each grid may include one or more cursors, and the cursors may be vertical cursors (as shown) or horizontal cursors. User input can move the cursors (horizontal movement for a vertical cursor, and vertical movement for a horizontal cursor).

The bottom-left display grid 120 includes multiple mathematical traces F1 and F2. A mathematical trace may be a series of data values that result from the mathematical transformation of another trace. The other trace that serves as a source for the mathematical transformation can be a currently-acquired trace (e.g., those in the upper-left grid 110), a memory trace (e.g., those in upper-right grid 130), or a zoom trace (e.g., those in lower-right grid 140). The mathematical transformation can include taking the source trace and applying a mathematical function to that trace. An example mathematical function can include taking the absolute value of the input trace. For example, applying this mathematical transformation to the sinusoidal acquisition trace C1 that is shown in FIG. 1 would result in a rectified sinusoidal signal (e.g., one with humps only facing upwards, rather than alternating upward/downward). The mathematical trace may be data values that are not displayed in grid 120, and that are generated from a source trace that are not presented in its respective grid. In other words, the mathematical transformation may occur for off-screen data.

Another example mathematical function is an averaging function. This function may average the signals in an input trace waveform over a period of time, which can effectively reduce a display of noise within the waveform. Another example, mathematical function is a Fast Fourier Transform (FFT), which can take an input trace and generate a frequency-domain representation of the waveform represented by that input trace. Other mathematical functions can include calculating a derivative of a trace, calculating a log of a trace (in base e or base 10), or calculating a sum of two separate traces.

The top-right display grid 130 shows memory traces M1 and M2 that were previously stored by the electronic device (or that were imported from a remote location, for example, as a file transfer over the Internet). A memory trace may have been a snapshot of a trace that was being acquired in real time (e.g., trace C1), but may also be a snapshot of a math trace or a snapshot of a zoom trace. A memory trace may be a graphical representation of the data values that were stored for the respective trace (or at least a portion thereof).

The bottom-right display grid 140 shows zoomed traces Z1 and Z2. A zoomed trace may show a zoomed portion of source trace. The source trace may be an acquisition trace, a math trace, or a memory trace.

Near the bottom of the user interface is a measurement table (6). The measurement table may display measurements for various traces.

At the bottom of the user interface (from the left to the middle) are groups of trace descriptor buttons (7), (8), (9), and (10). Each trace that is shown in the user interface (e.g., in the grids) may have its own descriptor button. In this example, each descriptor button is a box or user interface element that presents data that identifies characteristics of its respective trace and/or the channel on which the trace occurred. For example, each descriptor button may include the name of its corresponding trace. Here, the name is presented in the upper-left corner of the descriptor button (e.g., as C1, C2, F1, F2, Z1, Z2, M1, and M2).

If the trace uses another trace as a runtime input so that the destination trace updates to reflect runtime changes to the source trace (e.g., as do the mathematical and zoom traces), the descriptor button identifies the input trace in the upper-right portion of the descriptor button. For example, the descriptor button for the F1 math trace (i.e., the left of the two math descriptor buttons (8)) uses the C1 acquisition trace as an input waveform, and therefore applies its mathematical function to the C1 trace (at least the portion that is currently displayed in the user interface). As another example, the descriptor button for the Z1 zoom trace shows that the Z1 zoom trace also uses the C1 acquisition trace as an input waveform. The Z1 zoom trace therefore presents a zoomed version of the C1 acquisition trace. The lower, body portion of each descriptor button shows various other characteristics or settings of the respective trace or channel for which the descriptor button is displaying information. This data can include the scale that is used to present the trace (e.g., the volts per division and the units of time per division).

Each trace can also be associated with various other characteristics that may not be presented by its respective descriptor button. For instance, the math traces may be associated with or otherwise assigned to one of the multiple mathematical functions that are described above, and that are used to compute the respective mathematical trace, but those mathematical functions may not be indicated by each trace's respective descriptor button. As another example, each zoom trace may be associated with zoom factors, which may be scales for zooming the source trace in the x and y directions. As yet another example, the acquisition traces may be associated with a bandwidth limit characteristic (e.g., full bandwidth or 200 MHz bandwidth), a coupling characteristic (e.g., AC or DC coupling), and an input impedance characteristic (e.g., 50 ohm or 1M ohm). User input may specify these additional characteristics, for example, by selecting the respective descriptor button to cause an additional window to appear, in which these characteristics may be specified.

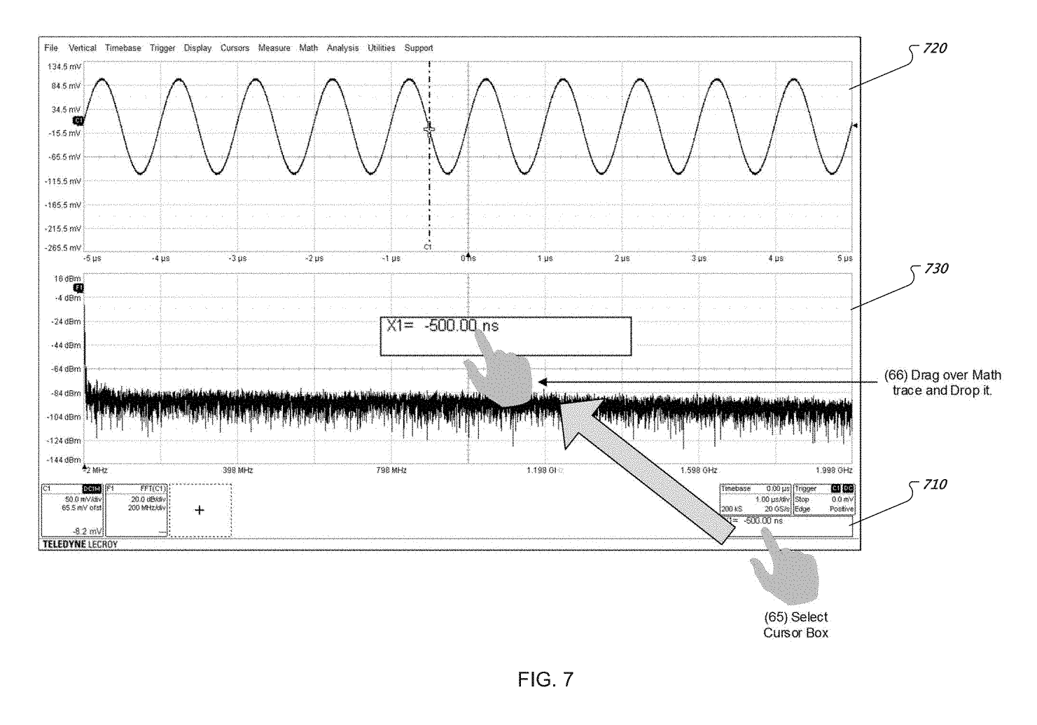

Also at the bottom of the user interface (but to the right) is a timebase descriptor button (11). Next to the timebase descriptor button is a trigger descriptor button (12), which can show the values of the trigger that is applied to the traces/channels in one or multiple of the grids. Below the timebase descriptor is a cursor box 150 (also identified as item 710 in FIG. 7).

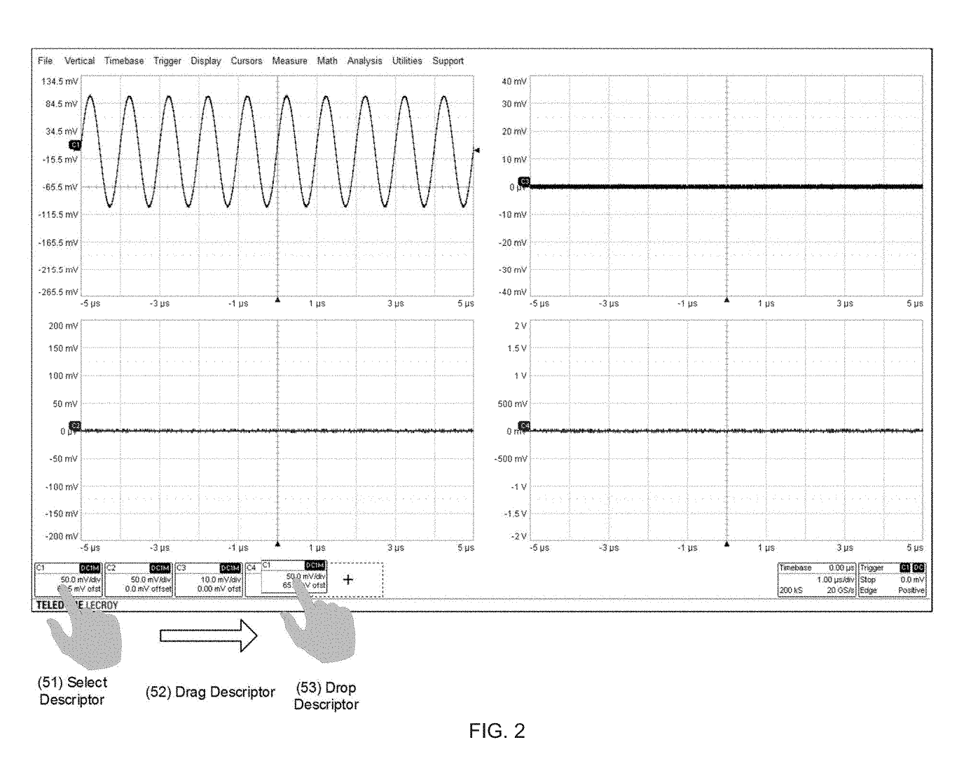

FIG. 2 shows a user input action for copying a configuration from one trace to another (from C1 to C4 in this example). In this example, the user interface is displaying four traces on four respective grids in the display. All of the grids present acquisition traces, but the traces use different channels of the oscilloscope for their sources. In this example, it only appears that the trace C1 is presenting information for a channel that has its probe connected to a signal source.

The user may desire to copy the properties of trace C1 to trace C4, and therefore may select the C1 descriptor button and drag it to and drop it over the C4 descriptor button. Doing so may copy all or at least some of the properties for trace C1 into trace C4. In other words, trace C4 may acquire the bandwidth limits, the coupling, and the input impedance characteristics that are set for trace C1, including additional display characteristics, such as the displayed scale. This updating of trace C4's characteristics can affect the operation of hardware of the electronic device, for example, by changing physical characteristics of the device to set the bandwidth limits, the coupling, and the input impedance of the channel under test. Trace C4, however, may still measure the waveform that is input at the C4 input port.

This copying operation may occur between other descriptor buttons, so long as the initially-selected descriptor button and the descriptor button on which the user released are of a same type (e.g., both acquisition descriptor buttons or both math descriptor buttons). As an example, when copying from a first math descriptor button to a second math descriptor button, the name of the second math descriptor button may remain the same, but the second math descriptor button may be updated with all or at least some of the properties of the first math descriptor button. These properties may include the source, the type of mathematical operation, the scale for the display, etc. A similar type of copying operation may occur for dragging and dropping between memory trace descriptor buttons or two zoom trace descriptor buttons (in which the name stays the same, but all or multiple other characteristics are updated).

A difference between copying between channel descriptor buttons and copying between math or zoom descriptor buttons is that copying between channel descriptor buttons may leave the source channel fixed. This may be because channel traces may be specifically designated as acquiring data for that trace's particular channel, and the source channel may not be modifiable. All other trace characteristics other than name, however, may copy from the source trace to the destination trace.

The copying user interface interaction may include the computing system receiving user input at a location at which a first descriptor button is being displayed (51), dragging that user input to another location of the user interface at which a second descriptor button is being displayed (52), and releasing the user input when it is located over the second descriptor button (53). In some examples, the user may not release his finger from the display during this process (except for the final release at the second descriptor button). As such, the user may perform the copying operation with a single-input user gesture. A similar single-input user gesture can include the user selecting the first descriptor box by clicking a mouse button, dragging the first descriptor box to the second descriptor box while holding down the mouse button, and releasing the mouse button when the cursor hovers over the second descriptor box.

During this drag and drop process, the electronic device may show the descriptor box (or a copy thereof) moving with the location of the user contact with the display to correspond to the location of the user contact with the display (as illustrated in FIG. 2). Other interactions with the descriptor boxes that would result in the same copying action are contemplated, such as dragging and dropping in the opposite direction (from destination to source), or tapping/clicking/swiping on the first descriptor box and thereafter tapping/clicking/swiping on the second descriptor box without dragging, or vice versa, in some examples without any intervening user input or with intervening user input that selects a copying user input element. These variations can also apply to the other operations described throughout this disclosure that involve selection of two user interface elements. Selection of a user interface element may involve that user interface element changing in shape, shading, and/or color.

In some examples, a user may move traces or add traces to a grid by dragging from the descriptor button for a trace and dropping that descriptor button on the grid for which it is to appear (or vice versa). In doing so, if the dragged and dropped trace is on another grid, the trace may either now appear on two grids, or the trace may move from one grid to another.

When the user selects a first descriptor button and drops that descriptor button on a second descriptor button, but the buttons are for different types of traces, another type of operation (e.g., a non-copying operation) may occur.

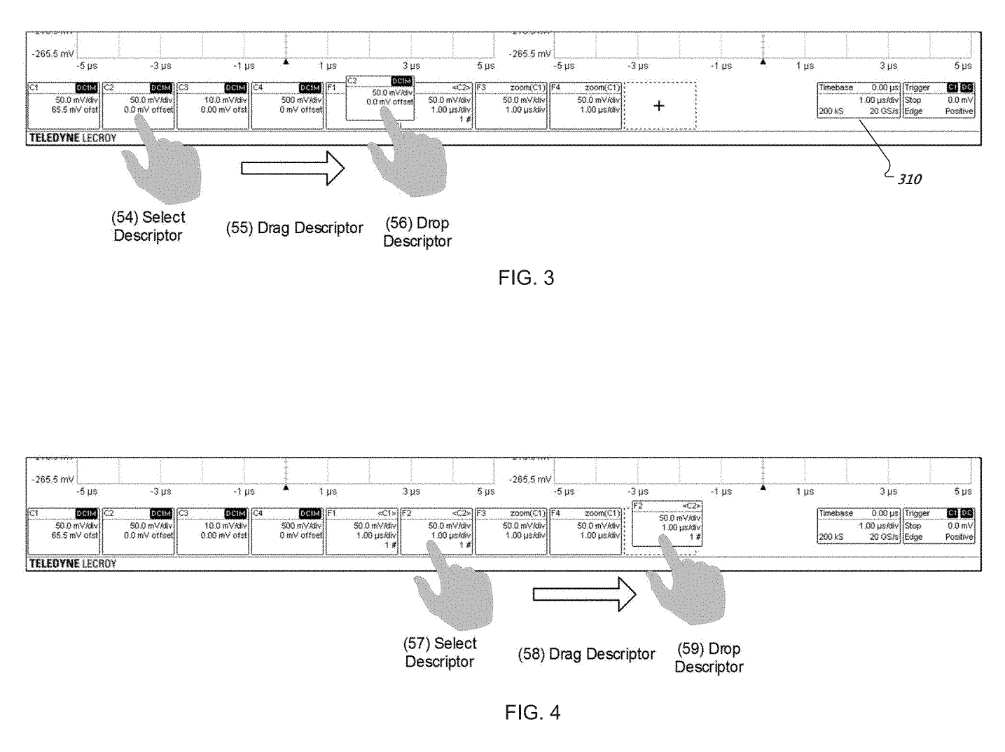

FIG. 3 shows a user input action for changing a source of a trace from a previous source to a new source. In this example, the user desires to change the source of trace F1 from trace F3 to trace C1. To do so, the user places his finger on the descriptor box for trace C2 and drags that descriptor box over to the descriptor box for F1 and releases. As a result, the upper right corner of the descriptor box for trace F1 updates from showing that its source is trace F3 to showing that its source is trace C2. Also as a result, the mathematical transformation that is used to generate the F1 trace uses trace C2 as an input rather than trace F3.

This user input action for changing a source of a trace is similar in many respects to that for copying trace settings from one trace to another. The user input action may occur using a finger on a touchscreen that drags a descriptor box from one location to another location, may occur using a mouse cursor that drags a descriptor box, or may use touch user input or mouse cursor user input to tap, click, swipe, or otherwise select each of the descriptor boxes.

This source-changing type of user input action may occur between most pairs of descriptor boxes. It is also possible that in some implementations, dragging between two types of the same descriptor box performs a source-changing operation rather than a copying operation (e.g., when the device has been configured to perform source-changing for selection of the same type of descriptor boxes). For example, a user may drag a descriptor box for an acquisition trace, a memory trace, a zoom trace, or even for another math trace (in some examples) onto a descriptor box for a math trace in order to assign the selected trace as the input trace for the math trace.

With a similar dragging operation, a user may change the input to a zoom trace, for example, by dragging a descriptor box for an acquisition trace, a math trace, a memory trace, or a zoom trace (in some examples). Since the acquisition traces do not have an input that is independent of the hardware assigned to each acquisition source, dragging descriptor box from a trace of any type other type may not have an affect. Similarly, dragging a descriptor box for a non-memory trace to a descriptor box for a memory trace may not have an affect (although in some examples such a user input would prompt the computing device to record data for the dragged trace and store it as a new memory trace or overwrite an existing memory trace).

In some implementations, since there may be at least two different types of actions that can occur when a user drags from one descriptor box to another (e.g., either copying or source-changing), the computing system may determine whether the source and destination descriptor boxes are of the same type or are of different types (e.g., where the types are acquisition trace, math trace, memory trace, and zoom trace). In response to such a determination, the computing system may activate the appropriate user input action.

FIG. 4 shows a user input action for adding a trace. In this example, a user wants to create a trace F5 (so named because there are already traces F1-F4). To do so, the user may select (57) the descriptor box for any of the existing math functions F1-F4, drag (58) the selected box to the “new” descriptor box user interface element 310 (see FIG. 3) that is illustrated by the box that includes a “+” symbol in the middle, and drop (59) the selected box. As a result, the computing system may generate trace F5 that uses default settings. Should the user want to copy settings for an existing trace into newly-created trace F5, the user could perform a copy user input action, for example, by dragging from the descriptor box for trace F2 onto the descriptor box for the newly-created trace F5. In some embodiments, when a user drags a descriptor box for trace F1 onto the “new” descriptor box, the electronic device generates a new descriptor box that uses settings from the dragged descriptor box (in this case F1) rather than default settings.

A user may create a “new” descriptor box for any of the types of descriptor boxes in this manner. Creating a new descriptor box may include adding a descriptor box to the display at the location of the “new” descriptor box 310, moving the display of the “new” descriptor box 310 to be adjacent to the newly-created descriptor box (e.g., to the right), and adding a trace that corresponds to the newly-created descriptor box in the body of the display (e.g., in an appropriate display grid).

In some examples, creating a new descriptor box for a trace as described above generates the newly-created trace in a default display grid (e.g., the left-most display grid or the upper-left-most display grid). In some examples, creating the new descriptor box for a trace may generate the newly-created trace in the same display grid as the initially-selected trace descriptor box (e.g., in FIG. 4, the newly-generated trace may be shown in the display grid in which trace F2 is presented). In some examples, a user may switch the display grid into which a particular trace is presented by selecting the descriptor box for that trace and dragging that descriptor box to a different display grid (or otherwise selecting both the descriptor box and the different display grid in some other manner, such as by tapping, as described elsewhere in this disclosure).

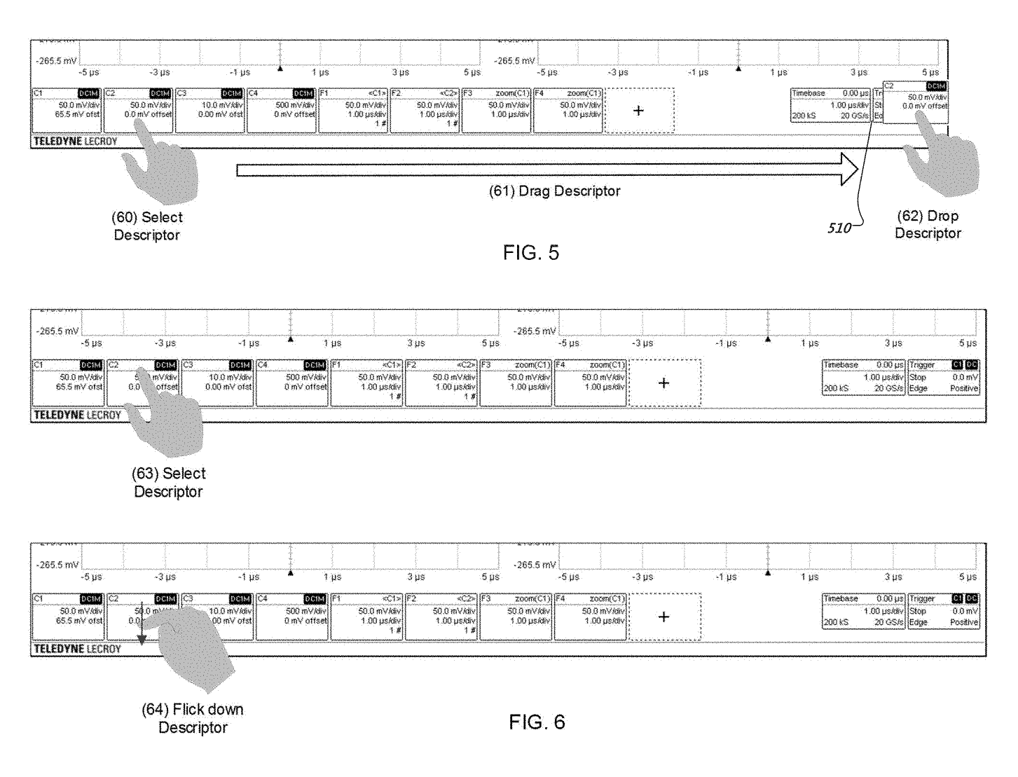

FIG. 5 shows a user input action for changing a source for the trigger. In this example, suppose that the source for the trigger was trace C1, and a user wanted to change the source to C2. The user may do so by selecting (60) the descriptor box for trace C1, dragging (61) that descriptor box, and dropping (62) that descriptor box on the descriptor box for the trigger 510. In some examples, the source for the trigger may have to be an acquisition trace, and dragging descriptor boxes for other types of traces may not have an affect. A user may select the descriptor box for the trigger 510 to change trigger characteristics, such as the trigger level, the type of trigger (e.g., positive edge or negative edge), and the slew rate.

FIG. 6 shows a user input action for removing a trace. In this example, suppose that a user wishes to remove trace C2. To do so, the user may select (63) the descriptor box for trace C2, and may flick to a side of the descriptor box (e.g., downwards, upwards, sideways) to remove trace C2. As a result, the descriptor box for trace C2 may disappear from the displayed collection of descriptor boxes, and the descriptor boxes for traces C3-F4 may slide to the left to take the place left by the removed descriptor box. Also as a result, the computing system may also remove the display of trace C2 from the display grid in which it was presented. If that display grid included another acquisition trace (e.g., trace C1), then the display grid may continue to display the other acquisition trace. If the display grid only included the trace that has been removed, then the computing system may show a blank display grid or may remove that display grid from the display (and other display grids may move and/or resize to fill the place of the removed display grid).

FIG. 7 shows a user input action for changing a cursor setting. A cursor box 710 may include a cursor setting that specifies the x value for a cursor in a first grid 720 that is presented by the display (or the corresponding y value in those examples in which a horizontal cursor is active). In response to a user selecting (65) the cursor box 710 and dragging (66) it to a second, different grid 730 on the display, the cursor box 710 may update to instead show the cursor setting for the second, different grid 730. In some examples, the cursor for the second, different grid is set at a location at which the user dropped the cursor box 710 or otherwise released from the display (tapping, clicking, or other alternative selections are also options). In other words, the cursor box 710 is selected by touch action (65), dragged over (66) to display area of math waveform trace F1, and dropped. This action can change the cursor setting from displaying a value of C1 (mV) to a value of F1 (dBm).

In some examples, should the user drag the cursor box to the first grid 720 and release, the cursor box 710 may still show a cursor setting for the first grid 720, but the cursor location (and thus the values in the cursor box) may update to the dropped location in the first grid. In some examples, should the user drag from a location on one of either display grids 720 or 730 and release at the cursor box 710, the cursor box 710 may update to display the cursor from the selected display grid (and in some examples may move the cursor to a location at which the user selected the display grid).

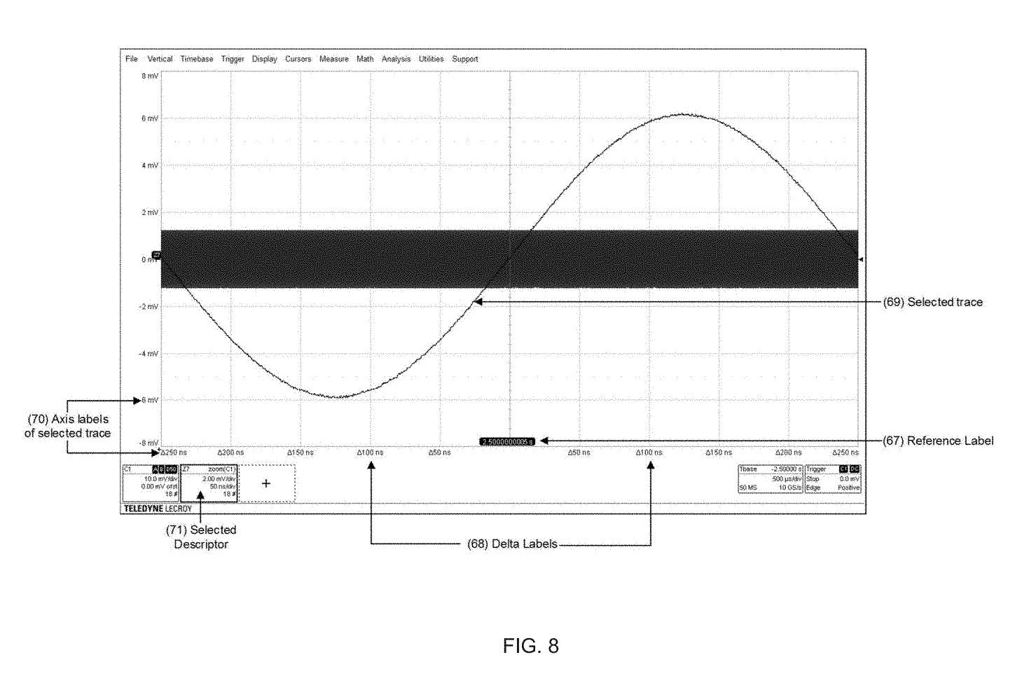

FIG. 8 shows a user interface that displays delta labels for a waveform trace. In FIG. 8, the reference label (67) on the display shows with greater resolution while the delta label (68) shows less resolution. This eliminates the problem of writing a large number of digits for each division. The selected waveform descriptor (71) is highlighted and the associated waveform trace (69) is shown in the only display grid. The axis labels (70) reflects properties of a selected descriptor box and its associated waveform trace.

Stated another way, sometimes grids may represent a small range of a very large waveform trace. In this case, it can become problematic to display grid scale labels showing the absolute values with full resolution. This can also cause difficulties in identifying the difference between two consecutive labels. For example, if the waveform trace contains a horizontal range of 2.499999990 s to 2.500000010, representing a horizontal scale of 2 ns/div with a trigger delay of 2.5 s, the grid labels for each division may be drawn as 2.499999990, 2.499999992, 2.499999994, 2.499999996, 2.499999998, 2.5, 2.500000002, 2.500000004, 2.500000006, 2.500000008, and 2.500000010. These labels require a good deal of horizontal space and the differences between adjacent labels can become difficult to quickly discern. An alternative is to draw only one grid label at full resolution at the center or another portion of the display (e.g., at a grid division line) and the remaining grid labels may be drawn as differences (deltas) from this reference.

For given examples, rather than displaying the long numbers above, the grid labels may be drawn as −Δ100 ns, −Δ80 ns, −Δ60 ns, −Δ40 ns, −Δ20 ns, 2.5 s, Δ20 ns, Δ40 ns, Δ60 ns, Δ80 ns, and Δ100 ns. The reference label may be displayed inside the grid, so that the margin area outside the grid does not need to become larger. Otherwise, the long reference label could require the grid area to be reduced. Since the delta labels do not take much space, they can be shown in the normal label positions just outside the grid, but also could be shown inside the grid. In some examples, the electronic device initially displays grid labels that show their entire horizontal range, but upon determining that a length of one or more of the labels exceeds an identified number of values, the electronic device switches to displaying delta labels. As such, as the user zooms into the display and the grid labels become longer and display more resolution, the device can change from displaying absolute labels to delta labels.

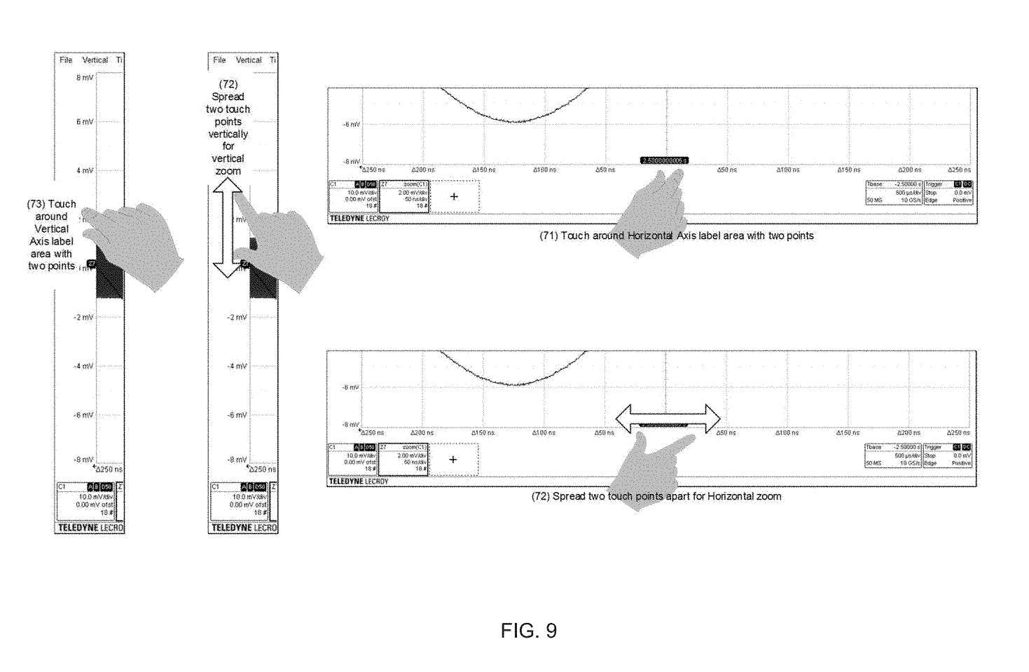

FIG. 9 shows a user input action for pinch zooming. The touch actions (71) and (72) demonstrate the action for pinch zoom in the horizontal direction while touch actions (73) and (74) demonstrate the action for pinch zoom in the vertical direction around an axis label area. User input may also zoom out by spreading fingers when they are in contact with the display.

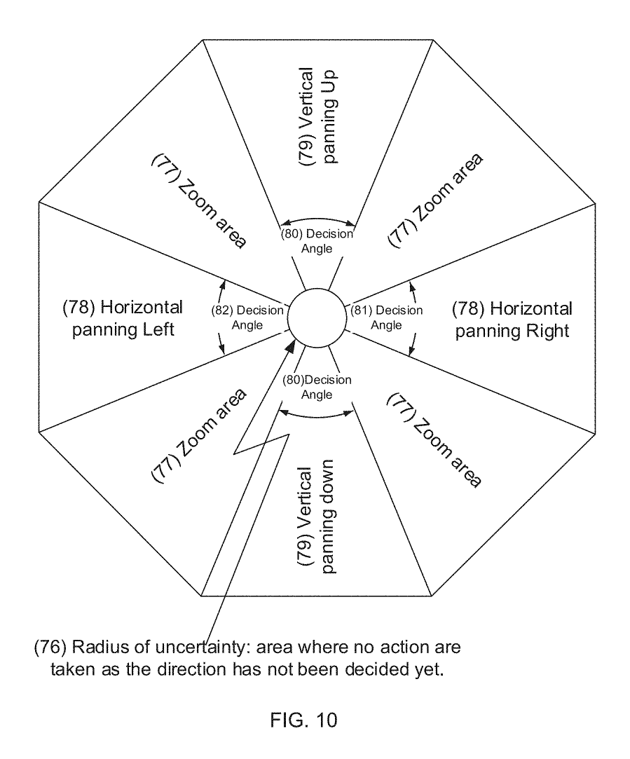

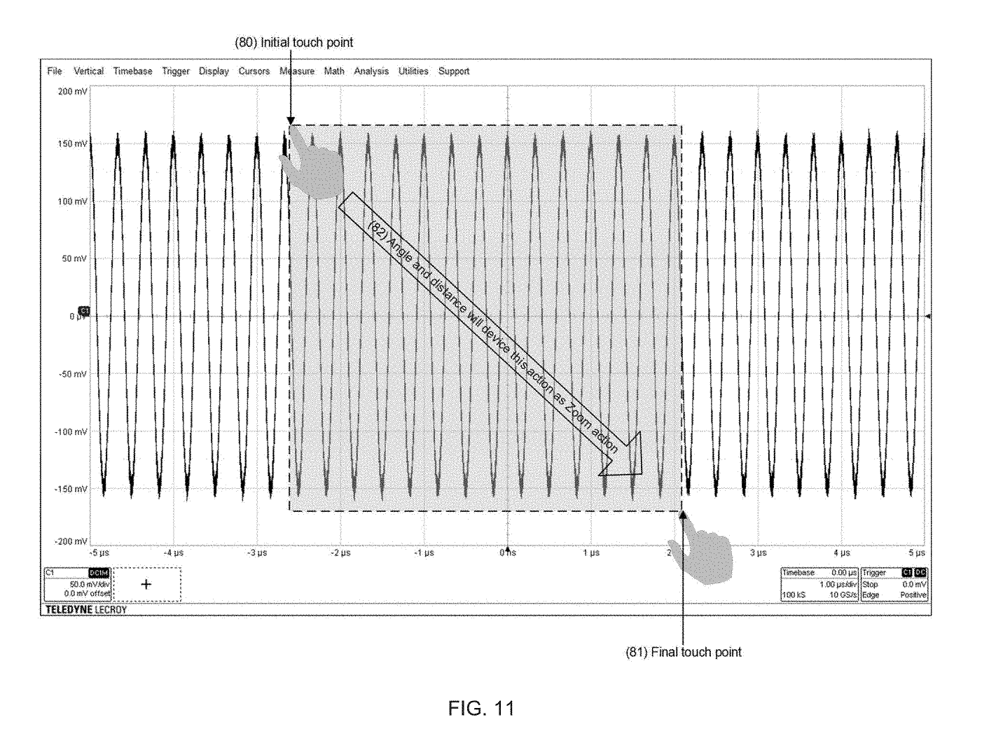

FIG. 10 shows a decision scheme for a user input action. User input has been able to zoom a grid to show a portion of a trace by touching or clicking with a mouse on the grid area of the display. By holding down the mouse button or by pressing against the touch panel with the pointing device and moving the pointing device, a square area could be defined and a zoom descriptor for the selected area could be enabled.

The electronic devices described herein permits a user to touch the display with a finger or mouse cursor and pan left/right up/down, in addition to zooming. To enable both of these functions with a single finger (i.e., both panning and zooming) a decision scheme has been employed. With this scheme, the electronic device detects that user input contacted the display, and should the user input move a threshold distance away from the point of initial contact, the electronic device determines the location of the user input and, based on that location, determines which type of user input action to activate.

Stated another way, should the user input move a predetermined distance in a direction (e.g., past the circle boundary in FIG. 10), then the electronic device can determine whether the location of the user input falls within areas 77, 78, or 79. This determination can be performed by comparing an actual location of the user input to regions associated with different user inputs. The determination can also be performed by other determinations that provide the same or a similar result, for example, by analyzing the angle of the user input movement and comparing that angle to designated angles that are associated with different user inputs. If the user input is determined to be in a horizontal panning region (78) or a vertical panning region (79), then the computing device may perform a panning user input action, for example by panning the display to correspond to movement of the user input. If the user input is determined to be in a zoom area 77 then the electronic device may perform a zooming operation.

With a zooming operation, the electronic device may display a box or other shape on the user interface (e.g., as shown in FIG. 11), with one corner or portion of the shape set at a location that correspond to initial contact of the user input, and with the opposite corner or portion of the shape movable to track (82) the location of the user's finger on the display. As such, a user may essentially “draw” a box or other shape on the user interface with his or her finger or with a mouse cursor, by contacting the display and then moving that contact away from that initial point of contact generally at a particular angle (e.g., at roughly 45 degrees to the upper right, lower right, lower left, or upper left). Otherwise, the electronic device may detect a panning operation and may pan the display.

Should the user invoke a zooming operation, and then release (81) his or her finger or mouse cursor from the display once the box reaches a user-determined size and shape, the electronic device may react by zooming to the area that was presented within the box. The device may zoom by changing a scale of a grid in which the user dragged to create the box, or the device may zoom by presenting a zoom trace (new or updated) in another grid with scale characteristics specified by the zooming operation.

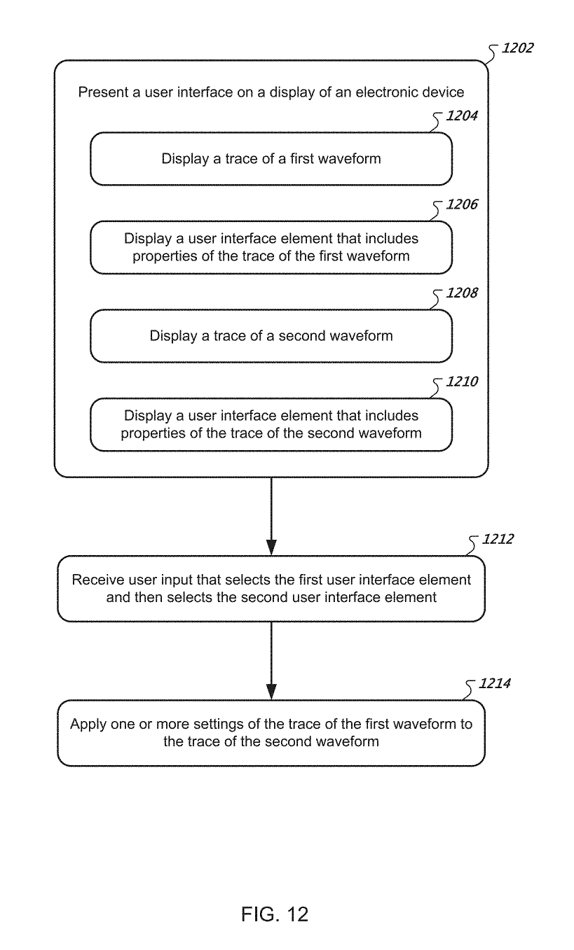

FIG. 12 shows a flowchart for modifying settings of an electronic test instrument.

At box 1202, the electronic device presents a user interface on a display of the electronic device. For example, an oscilloscope may present the user interface that is shown in FIG. 1 on a touchscreen display of the oscilloscope. In various embodiments, the electronic device may be another electronic test or measurement device, such as a spectrum analyzer, a function generator, or a general-purpose computer that is configured to perform electronic test and measurement operations.

At box 1204, the user interface includes a display of a trace of a first waveform. For example, the user interface may include a display of the trace C1 that is shown in FIG. 1 within display grid 110.

At box 1206, the user interface includes a display of a user interface element that includes properties of a trace of the first waveform. For example, the user interface may include one or more of the channel descriptor buttons (7) for C1, as shown in FIG. 1. Each channel descriptor button may include data that identifies a name of the corresponding trace and a name of a source of the trace, among other data that is described throughout this disclosure, surrounded by a border and movable as a whole when dragged by user input.

At box 1208, the user interface includes a display of a trace of a second waveform. For example, the user interface may include a display of the trace C2 within display grid 110, or may include a display of the trace F1 within display grid 120. Each display grid may be presented at a different portion of the user interface and may each display its own x and y axis labels, which may differ among the different display grids.

At box 1210, the user interface includes a display of a user interface element that includes properties of a trace of the second waveform. For example, the user interface may include one or more of the channel descriptor buttons (7) for C2, or may include one or more of the channel descriptor buttons (8) for F1, as shown in FIG. 1.

At box 1212, the electronic device receives user input that selects the first user interface element and then selects the second user interface element in response. For example, the electronic device may detect that a user dragged from a first descriptor button to a second descriptor button and then released. As described throughout this disclosure, user input can select the user interface elements in other ways, such as by tapping the first descriptor button and then tapping the second descriptor button.

At box 1214, the electronic device applies one or more settings of the trace of the first waveform to the trace of the second waveform. For example, in response to the electronic device determining that the traces associated with the first descriptor button and the second descriptor button are for the same types of traces, the electronic device may perform the copying functions that are described throughout this disclosure. In response to the electronic device determining that the traces associated with the first descriptor button and the second descriptor button are for different types of traces, the electronic device may perform the source update functions that are described throughout this disclosure.

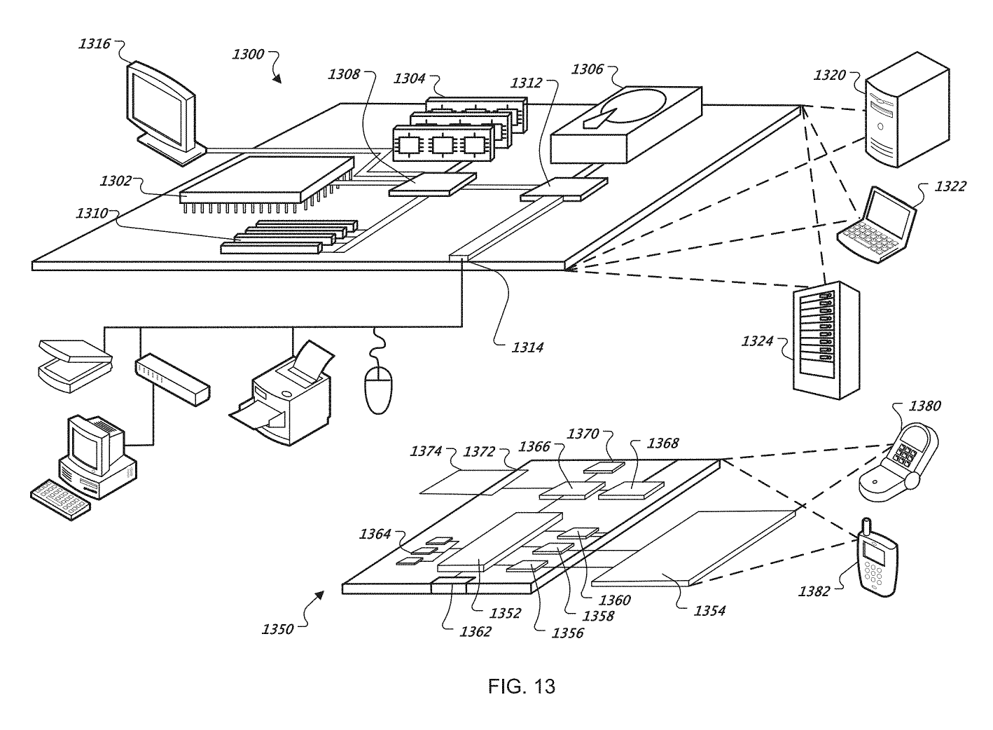

FIG. 13 is a block diagram of computing devices 1300, 1350 that may be used to implement the systems and methods described in this document, as either a client or as a server or plurality of servers. Computing device 1300 is intended to represent various forms of digital computers, such as laptops, desktops, workstations, personal digital assistants, servers, blade servers, mainframes, and other appropriate computers. Computing device 1350 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 1300 includes a processor 1302, memory 1304, a storage device 1306, a high-speed interface 1308 connecting to memory 1304 and high-speed expansion ports 1310, and a low speed interface 1312 connecting to low speed bus 1314 and storage device 1306. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high-speed interface 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high-speed controller 1308 manages bandwidth-intensive operations for the computing device 1300, while the low speed controller 1312 manages lower bandwidth-intensive operations. Such allocation of functions is by way of example only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed expansion port 1314. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. Additionally, the processor may be implemented using any of a number of architectures. For example, the processor 1302 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1350, such as control of user interfaces, applications run by device 1350, and wireless communication by device 1350.

Processor 1352 may communicate with a user through control interface 1358 and display interface 1356 coupled to a display 1354. The display 1354 may be, for example, a TFT (Thin-Film-Transistor Liquid Crystal Display) display or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provided in communication with processor 1352, so as to enable near area communication of device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to device 1350 through expansion interface 1372, which may include, for example, a SIMM (Single In Line Memory Module) card interface. Such expansion memory 1374 may provide extra storage space for device 1350, or may also store applications or other information for device 1350. Specifically, expansion memory 1374 may include instructions to carry out or supplement the processes described above, and may include secure information also. Thus, for example, expansion memory 1374 may be provided as a security module for device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352 that may be received, for example, over transceiver 1368 or external interface 1362.

Device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1368. In addition, short-range communication may occur, such as using a Bluetooth, WiFi, or other such transceiver (not shown). In addition, GPS (Global Positioning System) receiver module 1370 may provide additional navigation- and location-related wireless data to device 1350, which may be used as appropriate by applications running on device 1350.

Device 1350 may also communicate audibly using audio codec 1360, which may receive spoken information from a user and convert it to usable digital information. Audio codec 1360 may likewise generate audible sound for a user, such as through a speaker, e.g., in a handset of device 1350. Such sound may include sound from voice telephone calls, may include recorded sound (e.g., voice messages, music files, etc.) and may also include sound generated by applications operating on device 1350.

The computing device 1350 may be implemented in a number of different forms, some of which are shown in the figure. For example, it may be implemented as a cellular telephone 1380. It may also be implemented as part of a smartphone 1382, personal digital assistant, or other similar mobile device.

Additionally computing device 1300 or 1350 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method, comprising:
presenting, by an electronic device, a user interface on a display of the electronic device, the user interface including:
(i) a trace of a first waveform,
(ii) a first user interface element that is associated with the trace of the first waveform and that presents multiple properties of the first waveform or a channel on which the first waveform was acquired,
(iii) a trace of a second waveform, and
(iv) a second user interface element that is associated with the trace of the second waveform and that presents multiple properties of the second waveform or a channel on which the second waveform was acquired;
receiving, by the electronic device, user input that selects the first user interface element and then selects the second user interface element in response; and
applying, by the electronic device as a result of the electronic device receiving the user input that selects the first user interface element and then selects the second user interface element in response, one or more settings of the trace of the first waveform to the trace of the second waveform.

2. The computer-implemented method of claim 1, wherein:
receiving the user input that selects the first user interface element and then selects the second user interface element includes receiving an indication that the user input (i) contacted the display of the electronic device at a displayed location of the first user interface element, (ii) dragged, without release from the display, to a displayed location of the second user interface element, and (iii) released from display at the displayed location of the second user interface element.

3. The computer-implemented method of claim 1, wherein:
the multiple properties of the first waveform or the channel on which the first waveform was acquired include multiple of:
(i) type of coupling,
(ii) input impedance,
(iii) bandwidth limits,
(iv) type of mathematical function,
(v) zoom factor, and
(vi) source trace; and
the multiple properties of the second waveform or the channel on which the second waveform was acquired include multiple of:
(i) type of coupling,
(ii) input impedance,
(iii) bandwidth limits,
(iv) type of mathematical function,
(v) zoom factor, and
(vi) source trace.

4. The computer-implemented method of claim 1, wherein:
the first trace of the first waveform is one of:
(i) an acquisition channel trace,
(ii) a zoom mathematical trace,
(iii) a zoom trace, and
(iv) a memory trace; and
the second trace of the second waveform is one of:
(i) an acquisition channel trace,
(ii) a zoom mathematical trace,
(iii) a zoom trace, and
(iv) a memory trace.

5. The computer-implemented method of claim 1, wherein:
the trace of the first waveform is a trace of a particular type that is selected from a group consisting of (i) an acquisition channel trace, (ii) a zoom mathematical trace, (iii) a zoom trace, and (iv) a memory trace;
the trace of the second waveform is a trace of the particular type;
the method further comprises determining, by the electronic device, that the trace of the second waveform is of a same type as the trace of the first waveform; and
applying the one or more settings of the trace of the first waveform to the trace of the second waveform includes, as a result of having determined that the trace of the second waveform is of the same type as the trace of the first waveform, replacing multiple settings of the trace of the second waveform with multiple settings of the trace of the first waveform, such that the second user interface element updates from presenting the multiple properties of the second waveform or the channel on which the second waveform was acquired to presenting the multiple properties of the first waveform or the channel on which the first waveform was acquired.

6. The computer-implemented method of claim 5, wherein applying the one or more settings of the trace of the first waveform to the trace of the second waveform includes, as a result of having determined that the trace of the second waveform is of the same type as the trace of the first waveform, replacing multiple settings of the trace of the second waveform with multiple settings of the trace of the first waveform, such that the trace of the first waveform is presented at a location of the display at which the trace of the first waveform was previously presented and is newly-presented at a position of the display at which the trace of the second waveform was previously presented.

7. The computer-implemented method of claim 1, wherein:
the trace of the first waveform is a trace of a particular type that is selected from a group consisting of (i) an acquisition channel trace, (ii) a zoom mathematical trace, (iii) a zoom trace, and (iv) a memory trace; and
the trace of the second waveform is a type of trace that is different from the particular type and that is selected from the group consisting of (i) an acquisition channel trace, (ii) a zoom mathematical trace, (iii) a zoom trace, and (iv) a memory trace;
the method further comprises determining, by the electronic device, that the trace of the second waveform is of a different type than the trace of the first waveform; and
applying the one or more settings of the trace of the first waveform to the trace of the second waveform includes, as a result of having determined that the trace of the second waveform is of the different type than the trace of the first waveform:
(a) modifying a source of the trace of the second waveform from being a previous trace to being the trace of the first waveform, and
(b) maintaining multiple settings of the trace of the second waveform while the source of the trace of the second waveform has changed.

8. The computer-implemented method of claim 1, wherein:
the first user interface element is presented outside of a first display grid within which the trace of the first waveform is presented; and
the second user interface element is presented outside of a second display grid within which the trace of the second waveform is presented.

9. A system comprising:
one or more processors; and
one or more computer-readable devices, including instructions stored thereon, which when executed by the one or more processors, cause performance of operations that include:
presenting, by an electronic device, a user interface on a display of the electronic device, the user interface including:
(i) a trace of a first waveform,
(ii) a first user interface element that is associated with the trace of the first waveform and that presents multiple properties of the first waveform or a channel on which the first waveform was acquired,
(iii) a trace of a second waveform, and
(iv) a second user interface element that is associated with the trace of the second waveform and that presents multiple properties of the second waveform or a channel on which the second waveform was acquired;
receiving, by the electronic device, user input that selects the first user interface element and then selects the second user interface element in response; and
applying, by the electronic device as a result of the electronic device receiving the user input that selects the first user interface element and then selects the second user interface element in response, one or more settings of the trace of the first waveform to the trace of the second waveform.

10. The system of claim 9, wherein:
receiving the user input that selects the first user interface element and then selects the second user interface element includes receiving an indication that the user input (i) contacted the display of the electronic device at a displayed location of the first user interface element, (ii) dragged, without release from the display, to a displayed location of the second user interface element, and (iii) released from display at the displayed location of the second user interface element.

11. The system of claim 9, wherein:
the multiple properties of the first waveform or the channel on which the first waveform was acquired include multiple of:
(i) type of coupling,
(ii) input impedance,
(iii) bandwidth limits,
(iv) type of mathematical function,
(v) zoom factor, and
(vi) source trace; and
the multiple properties of the second waveform or the channel on which the second waveform was acquired include multiple of:
(i) type of coupling,
(ii) input impedance,
(iii) bandwidth limits,
(iv) type of mathematical function,
(v) zoom factor, and
(vi) source trace.

12. The system of claim 9, wherein:
the first trace of the first waveform is one of:
(i) an acquisition channel trace,
(ii) a zoom mathematical trace,
(iii) a zoom trace, and
(iv) a memory trace; and
the second trace of the second waveform is one of:
(i) an acquisition channel trace,
(ii) a zoom mathematical trace,
(iii) a zoom trace, and
(iv) a memory trace.

13. The system of claim 9, wherein:
the trace of the first waveform is a trace of a particular type that is selected from a group consisting of (i) an acquisition channel trace, (ii) a zoom mathematical trace, (iii) a zoom trace, and (iv) a memory trace;
the trace of the second waveform is a trace of the particular type;
the operations further include determining, by the electronic device, that the trace of the second waveform is of a same type as the trace of the first waveform; and
applying the one or more settings of the trace of the first waveform to the trace of the second waveform includes, as a result of having determined that the trace of the second waveform is of the same type as the trace of the first waveform, replacing multiple settings of the trace of the second waveform with multiple settings of the trace of the first waveform, such that the second user interface element updates from presenting the multiple properties of the second waveform or the channel on which the second waveform was acquired to presenting the multiple properties of the first waveform or the channel on which the first waveform was acquired.

14. The system of claim 13, wherein applying the one or more settings of the trace of the first waveform to the trace of the second waveform includes, as a result of having determined that the trace of the second waveform is of the same type as the trace of the first waveform, replacing multiple settings of the trace of the second waveform with multiple settings of the trace of the first waveform, such that the trace of the first waveform is presented at a location of the display at which the trace of the first waveform was previously presented and is newly-presented at a position of the display at which the trace of the second waveform was previously presented.

15. The system of claim 9, wherein:
the trace of the first waveform is a trace of a particular type that is selected from a group consisting of (i) an acquisition channel trace, (ii) a zoom mathematical trace, (iii) a zoom trace, and (iv) a memory trace; and
the trace of the second waveform is a type of trace that is different from the particular type and that is selected from the group consisting of (i) an acquisition channel trace, (ii) a zoom mathematical trace, (iii) a zoom trace, and (iv) a memory trace;
the operations further include determining, by the electronic device, that the trace of the second waveform is of a different type than the trace of the first waveform; and
applying the one or more settings of the trace of the first waveform to the trace of the second waveform includes, as a result of having determined that the trace of the second waveform is of the different type than the trace of the first waveform:
(a) modifying a source of the trace of the second waveform from being a previous trace to being the trace of the first waveform, and
(b) maintaining multiple settings of the trace of the second waveform while the source of the trace of the second waveform has changed.

16. The system of claim 9, wherein:
the first user interface element is presented outside of a first display grid within which the trace of the first waveform is presented; and
the second user interface element is presented outside of a second display grid within which the trace of the second waveform is presented.
